(19) United States
(12) Patent Application Publication
(10) Pub. No.: US 2021/0007515 A1
(43) Pub. Date: Jan. 14, 2021

(54) KIOSK ASSEMBLIES HAVING INTERCHANGEABLE CORES AND VESSELS

(71) Applicant: Zivelo, Inc., Scottsdale, AZ (US)

(72) Inventors: David Tipp, Chandler, AZ (US); Graham Murdoch, Scottsdale, AZ (US); Darren Endo, Carefree, AZ (US)

(21) Appl. No.: 16/508,172

(22) Filed: Jul. 10, 2019

(51) Int. Cl. A47F 9/04; G06F 1/16; G06Q 20/18

(52) U.S. Cl. CPC A47F 9/04; G06Q 20/18; G06F 1/1632

(57) ABSTRACT

Systems, devices, and methods for genericizing a kiosk core include providing the core with one or more load bearing surfaces and a first electrical interface, and providing a plurality of vessels each having a load carrying interface configured to support the load bearing interface, and a second electrical interface configured to provide power to the core and/or provide data exchange between the core and one or more peripheral devices associated with the vessel.

### TECHNICAL FIELD

The present invention relates, generally, to modular kiosk systems and, more particularly, to a plurality of supporting vessels each configured to be paired with generic kiosk core.

### BRIEF BACKGROUND

Retail venues such as fast food restaurants increasingly employ interactive kiosks to process customer orders. As the demand for a feature rich user experience continues to rise, kiosk suppliers are challenged with providing low cost solutions for multiple kiosk support modalities (e.g., counter top, free standing, and wall mount supports).

Wallaby™ self-service stands from Elo Touch Solutions, Inc. include both free standing and counter top options for mounting interactive displays in high-traffic public environments. Point of sale and self-service applications including self-order, endless aisle, price verification, loyalty programs, brand experience, and patient check-in. The Wallaby stands can support 15-inch to 22-inch Windows or Android based self-service touchscreens complete with payment and printing capabilities. Both stands offer secure housing for a printer, and I/O connections for peripheral devices such as payment terminals, barcode scanners, and fingerprint readers. The display is secured to the stand using a bracket and fasteners which connect to the middle of the back of the display, yielding a “floating” look when viewed from the front.

Presently known display mounting systems are cumbersome and time consuming, requiring manual connection of both mechanical support structures as well as data and power lines.

### BRIEF SUMMARY

One embodiment of the present invention provides an interactive kiosk (referred to herein as a core) configured to be selectively paired with any one of a plurality of cradles or vessels, such as a counter top mount, a wall mount, or a free standing mount. The core housing includes a first mounting interface and each of the various vessels includes a common second mounting (or docking) interface. When the core is received within the vessel, the first and second interfaces cooperate to provide mechanical support for the core, as well as electrical connectivity between the core and the vessel. As such, the core may be transferred from one vessel to another without having to re-configure the core or the vessel. Because each vessel embodies a common mounting interface, the core is essentially agnostic to particular type of vessel it is paired with.

This arrangement permits the user to remove the core from one vessel (e.g., a counter top mount), seamlessly transfer it to another vessel (e.g., a wall mount), and immediately resume kiosk operation. In addition, by using gravity as a primary force to hold the core within the vessel, the time and complexity associated with screws and bolts may be avoided.

In a preferred embodiment, the first mounting interface is disposed proximate a bottom (e.g., downwardly facing) surface of the core, such that the weight of the core is supported from the bottom. Electrical connectivity may be in the form of pin connectors, a USB interface, or any other suitable wired or wireless interface protocol.

In another embodiment, the core module includes hardware for implementing basic functionality, such as a screen display, a control module (e.g., a computer), a navigation panel (e.g., an ADA or other assistive technology module), and/or a payment module such as a credit card magnetic stripe reader, chip reader, and/or a wireless payment interface. In various embodiments, the vessel may also include additional peripheral hardware for performing more advanced functions such as a bar code reader, receipt printer, biometric sensor, and/or a speaker.

In accordance with a further embodiment, the ADA navigation panel may be integrated into the display screen, for example with tactical navigation keys extending upwardly from the plane of the display screen

Other embodiments provide a modular kiosk system which includes a “generic” core which can be paired with a variety of vessels (e.g., counter top, free standing, wall mount) reduce total cost of ownership. In addition, the generic core may include basic functionality, whereas more advanced peripheral devices may be incorporated into various vessels.

[coon] Various other embodiments, aspects and features are of the present invention are described in more detail below. Additional features and characteristics will become apparent from the subsequent detailed description and the appended claims, taken in conjunction with the accompanying drawings and this background section.

### BRIEF DESCRIPTION OF THE DRAWING FIGURES

Exemplary embodiments will hereinafter be described in conjunction with the following drawing figures, wherein like numerals denote like elements, and:

FIG. 1 is a schematic perspective view of a counter top vessel and a core combination configured to be mechanically and electrically coupled together in accordance with various embodiments;

FIG. 2 is a schematic view of a pin connector module for facilitating electrical communication between a core and vessel in accordance with various embodiments;

FIG. 3 is a schematic perspective view of the core and vessel combination of FIG. 1 showing the core received within the vessel in accordance with various embodiments;

FIG. 4 is a side perspective view of an alternate embodiment of a core and vessel combination in accordance with various embodiments;

FIG. 5 is a perspective view showing the underside of the core and vessel combination of FIG. 4 in accordance with various embodiments;

FIG. 6 is a schematic perspective view of a further alternate embodiment of a core and vessel combination showing the core received within the vessel in accordance with various embodiments;

FIG. 7 is a perspective view showing the back side of the core and vessel combination of FIG. 6 in accordance with various embodiments;

FIG. 8 is a perspective view of an exemplary counter top vessel in accordance with various embodiments;

FIG. 9 is a schematic perspective view of a further alternate embodiment of a core and vessel combination showing the core received within the vessel in accordance with various embodiments;

FIG. 10 is a schematic perspective view of a further alternate embodiment of an exemplary core illustrating the core interface module in accordance with various embodiments;

FIG. 11 is a schematic perspective view of an exemplary vessel illustrating the vessel interface module configured to mate with a corresponding core interface module in accordance with various embodiments;

FIG. 12 is a cross section view of an exemplary core received within a vessel illustrating the mating of the core interface module with the vessel interface module in accordance with various embodiments;

FIG. 13 is a schematic perspective view of a free standing core and vessel combination showing the core received within the vessel in accordance with various embodiments;

FIG. 14 is an alternate view of a free standing core and vessel combination showing the core received within the vessel in accordance with various embodiments;

FIGS. 15 and 16 are back side schematic perspective views of alternate embodiments of a free standing core and vessel combinations in accordance with various embodiments;

FIGS. 17 and 18 are schematic perspective views of alternate embodiments of wall mounted core and vessel combination showing the core received within the vessel in accordance with various embodiments;

FIG. 19 is a front elevation schematic view of an exemplary core illustrating a display screen and various peripheral components in accordance with various embodiments;

FIG. 20 depicts a peripheral component disposed in a region of the front panel which extends beyond the touch sensitive region of the display in accordance with various embodiments; and

FIGS. 21-23 illustrate a universal mounting joint for mounting a core or a core/vessel system to a surface or other mounting configuration in accordance with various embodiments.

### DETAILED DESCRIPTION OF PREFERRED

### Exemplary Embodiments

The following detailed description is merely exemplary in nature and is not intended to limit the invention or the application and uses of the invention. Furthermore, there is no intention to be bound by any theory presented in the preceding background or the following detailed description.

Various embodiments relate to a novel kiosk core which may be interchangeably paired with a plurality of different vessels, while other embodiments relate to a modular system of cores and vessels, where the cores are essentially generic and can be used with any one of the vessels.

Referring now to FIG. 1, an exemplary core/vessel combination 100 for counter top use includes a core 102 configured to be mated with a vessel 104. The vessel 104 includes a mounting interface 106 which provides mechanical support and stability to the core. The core includes a corresponding core mounting interface located underneath the core (hidden from view in FIG. 1). In some embodiments, the vessel mounting interface 106 also includes an electrical interface component no which supplies power to the core and/or facilitates data transfer between the core and various peripheral devices (e.g., bar code scanner, printer, camera, microphone, assistive technologies, biometric sensors, printers, and the like). Electrical connectivity may be in the form of pin connectors, a USB interface, or any other suitable wired or wireless interface protocol. In this regard, the various peripheral devices may be integrated into the core, connected to the core, integrated into the vessel, connected to the vessel, or any combination of the foregoing.

The core mounting interface and the corresponding vessel mounting interface are configured to allow the user to visually align the core proximate the vessel, and then gently release the core into or onto the vessel. In a preferred embodiment, the weight of the core draws it into engagement with the vessel. That is, the user manually lines up the core with vessel using visual cues associated with the core and/or vessel mounting interfaces. Once the core is initially released by the user, the self-guiding (or self-aligning) structural features on the mating core and vessel mounting interfaces further urge the core into more intimate mechanical engagement with the vessel, assisted by gravity. In some embodiments this self-aligning feature also urges the core into electrical engagement with the vessel.

In various embodiments the self-guiding or self-aligning features (eg, surface 108) may include a key and a corresponding keyway, a loose fitting ball and socket arrangement, a pocket into which a protrusion is inserted, guide rails, tabs, hooks, clips, tongue-in-groove, tilted or inclined supporting surfaces, or other surfaces and/or features which facilitate “blind” gravity and/or manually assisted mechanical and/or electrical engagement between the core and vessel once the user roughly aligns the core mounting interface relative to the vessel mounting interface.

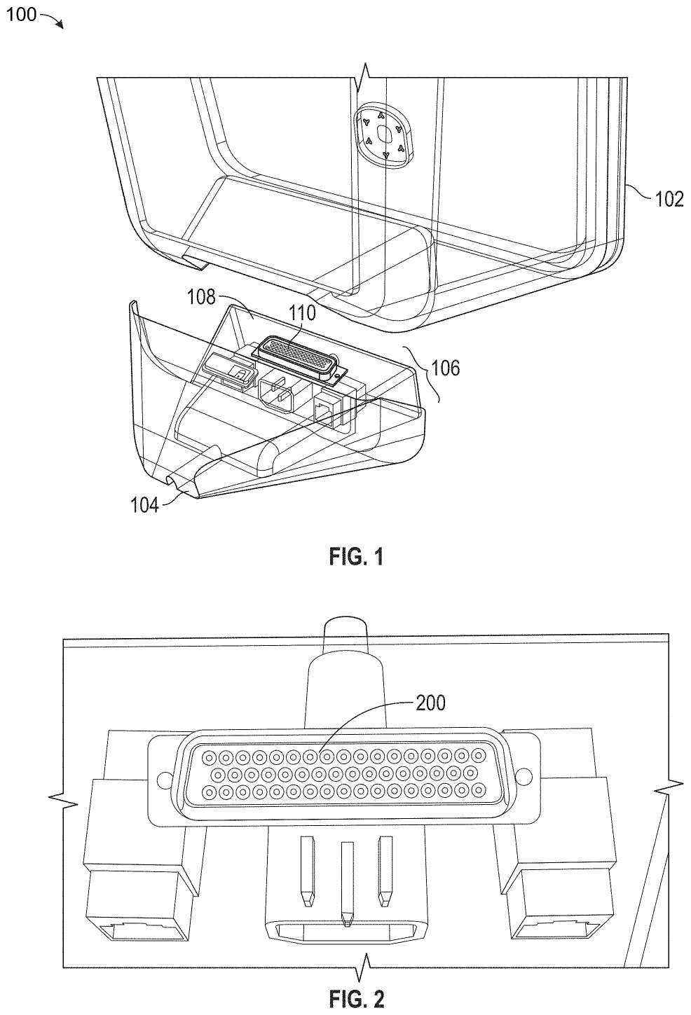

FIG. 2 is an exemplary pin connector module 200 for facilitating electrical communication between a core and a vessel.

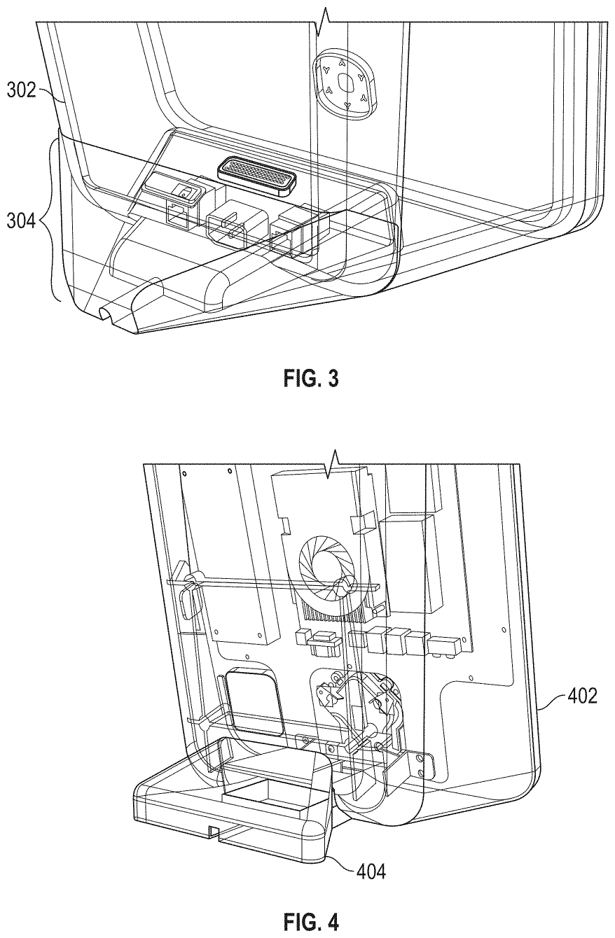

FIG. 3 illustrates a core 302 and vessel 304 combination generally analogous to that of FIG. 1, showing the core received within the vessel.

FIG. 4 is an alternate embodiment of a core 402 and vessel 404 showing the core mechanically (and perhaps also electrically) engaged with the vessel.

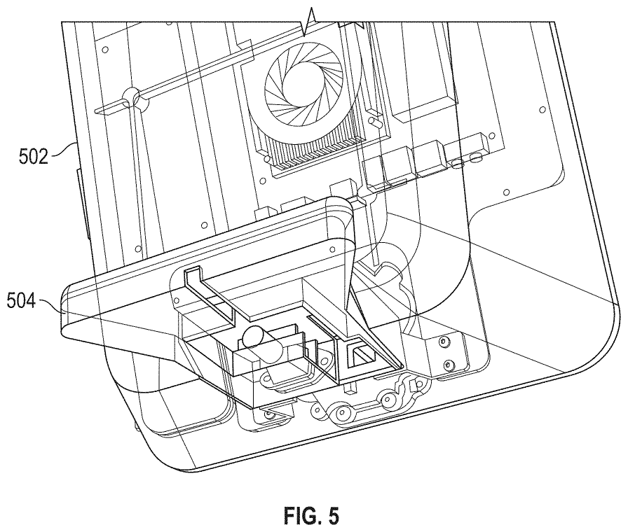

FIG. 5 shows the underside of a core 502 and vessel 504 combination, with the core received into and supported by the vessel in accordance with various embodiments.

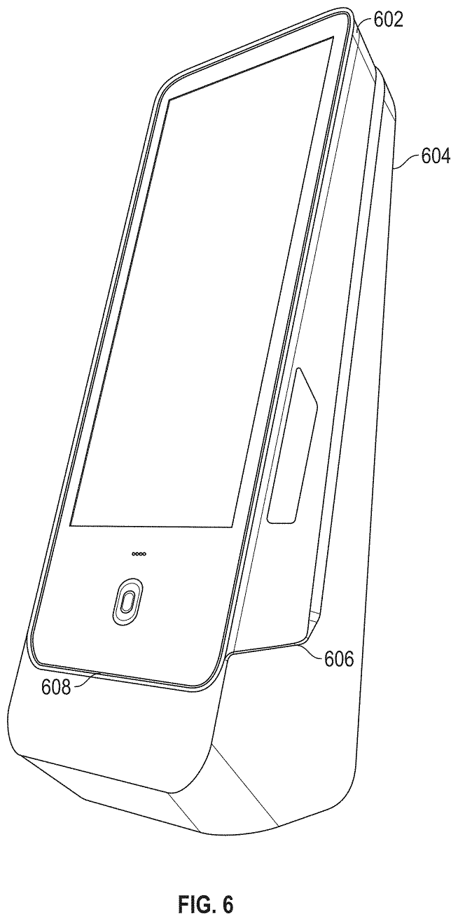

FIG. 6 is a further alternate embodiment of a core 602 received within and supported by a vessel 604, where the mating core and vessel mounting interfaces (hidden from view in FIG. 6) are joined along multiple support or bearing surfaces such as first and second mating regions 606 and 608. One or both of the mating regions 606, 608 may support the weight of the core, and may also facilitate electrical engagement between the core and the vessel.

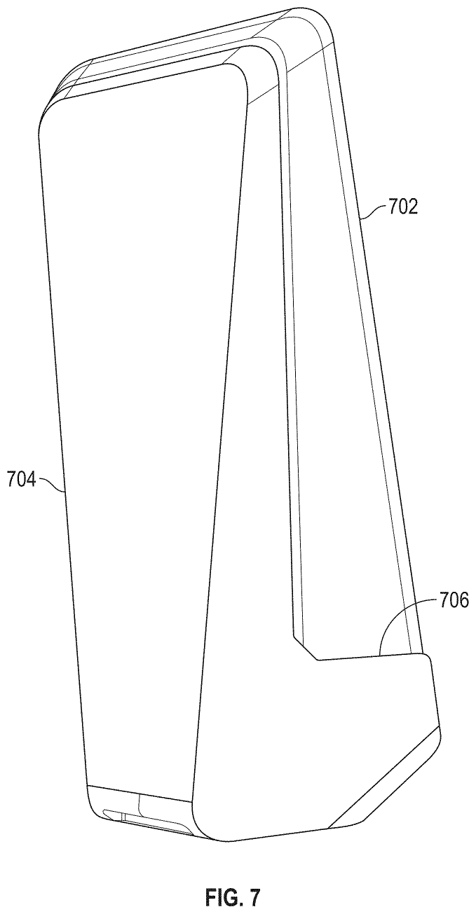

FIG. 7 is a perspective view showing the back side of the core 702 and a vessel 704 combination joined along a mating line 706. In the illustrated embodiment, mating line 706 schematically represents both the load bearing bottom surface of the core 702, as well as the load carrying surface of the vessel 704.

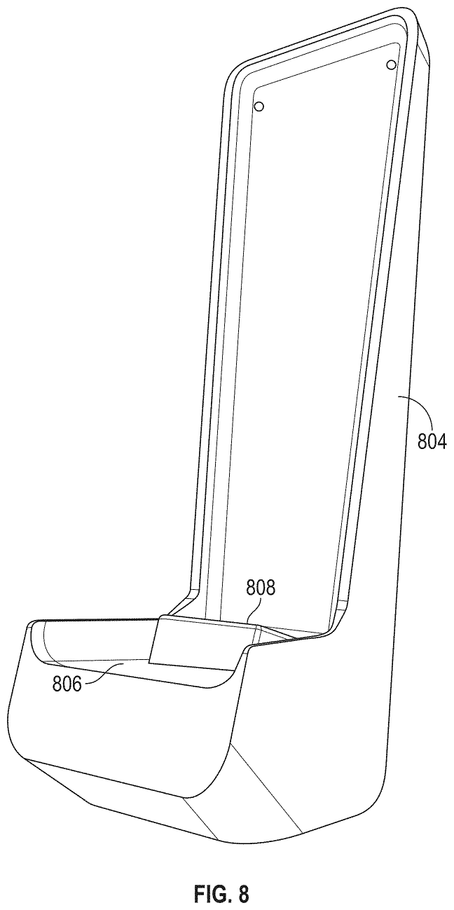

FIG. 8 shows an exemplary counter top vessel (shell) 804 depicting alternate load carrying surfaces, such as a first load carrying surface 806 and a second load carrying surface 808.

In the context of the present invention, each vessel may have one or more load carrying surfaces, regions, points, or structural features, singly and collectively referred to herein as a “load carrying surface” or “load carrying surfaces.” The load carrying surface (or surfaces) contacts and thereby mates with a corresponding load bearing surface on a core to provide structural support for the core, and support the weight of the core. In some embodiments, the core includes a single load bearing surface which is configured to mate with respective load carrying surfaces associated with a counter top, free standing, wall mount, or other (e.g., hybrid) vessel modality.

In other embodiments, the core may include first and second load bearing surfaces, where the first load bearing surface is configured to mate with a first load carrying surface on a first (e.g., counter top) vessel, and the second load bearing surface is configured to mate with a second load carrying surface on a second (e.g., wall mount) vessel. Regardless of whether the core includes one or a plurality of load bearing surfaces, the core is capable of being supported (and, hence, mating with) at least two different vessel styles or modalities.

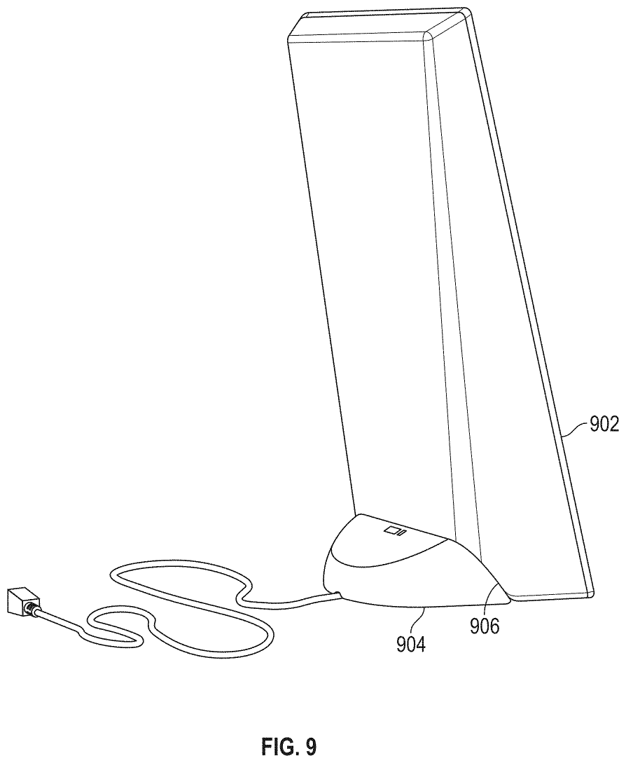

FIG. 9 is a schematic perspective view of a further alternate embodiment of a core 902 and vessel 904 combination showing the core received within the vessel and supported along a support interface 906. In the illustrated embodiment, the support interface 906 represents one or more load bearing surfaces mechanically supported by one or more load carrying surfaces, which are substantially hidden from view in FIG. 9. The core 902 and vessel 904 may also by joined at an electrical interface (not shown).

As discussed above, the electrical interface may comprise a core electrical interface configured to mate with a vessel electrical interface when the core is mechanically paired with the vessel to thereby communicate power and/or data between the core and any peripheral devices integrated with or otherwise supported by the vessel. Alternatively, the vessel may function as a “passive” electrical interface by providing pathways for cabling associated with one or more peripheral devices. In this passive embodiment, the power and/or data cabling may directly connect the core to the peripheral device(s), or the cabling may simply pass through the vessel and connect directly to a power/data bus or simply to a wall outlet, without otherwise interacting with the core.

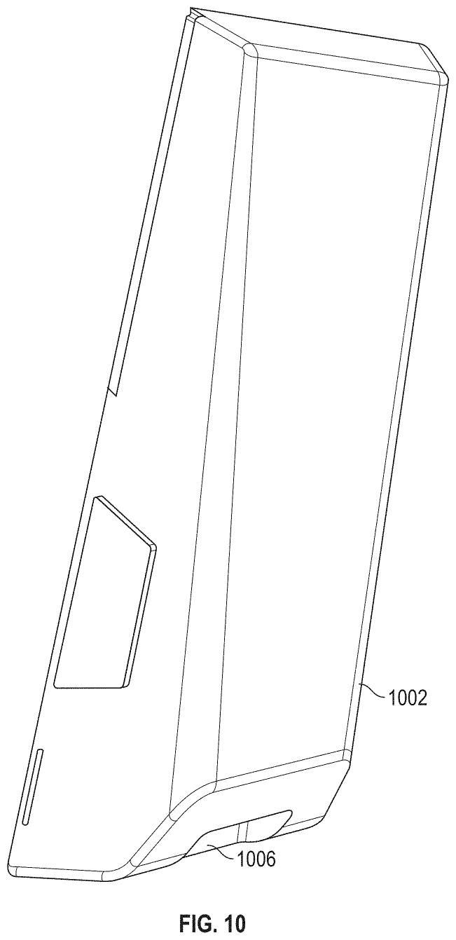

FIG. 10 is a schematic perspective view of a further alternate embodiment of an exemplary core 1002 including a core interface module 1006. The core interface module 1006 includes one or more load bearing surfaces configured to mate with corresponding load carrying surfaces associated with at least different vessels in accordance with the present invention. In addition, the core interface module 1006 may also include a core electrical interface (not shown in FIG. 10), as discussed above.

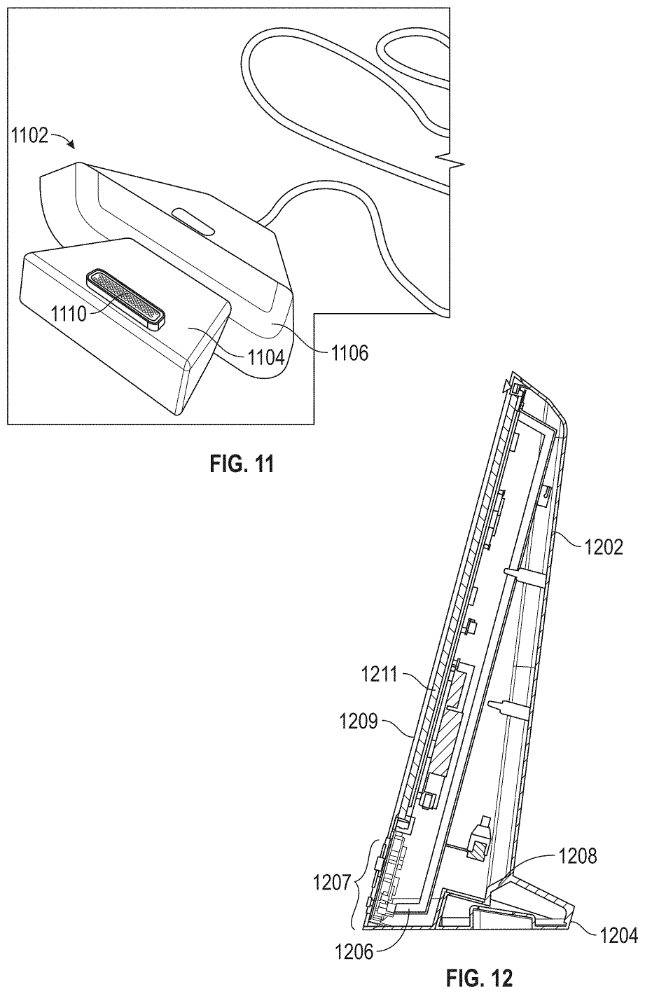

FIG. 11 is an exemplary vessel 1102 including a vessel interface module having respective load carrying surfaces 1104, 1106 configured to support one or more corresponding load bearing surfaces associated with a vessel. The vessel 1102 also includes an optional vessel electrical interface 1110 configured to mate with a corresponding core electrical interface when the core is mechanically supported by the vessel.

FIG. 12 is a cross section view of an exemplary core 1202 received within or otherwise supported by a vessel 1204 illustrating the mating of the core interface module with the vessel interface module along joint interface segments 1206, 1208, one or both of which may also comprise load bearing and load carrying surface interfaces.

FIG. 12 further depicts an ADA module, audio controls, and/or other peripheral components 1207 integrated into a touch screen 1209 overlaying a display 1211. In the illustrated embodiment, the touch screen extends beyond the underlying display; alternatively, the touch screen and display may be substantially coextensive, or the display portion may extend beyond the touch screen portion, as appropriate to accommodate one or more peripheral devices.

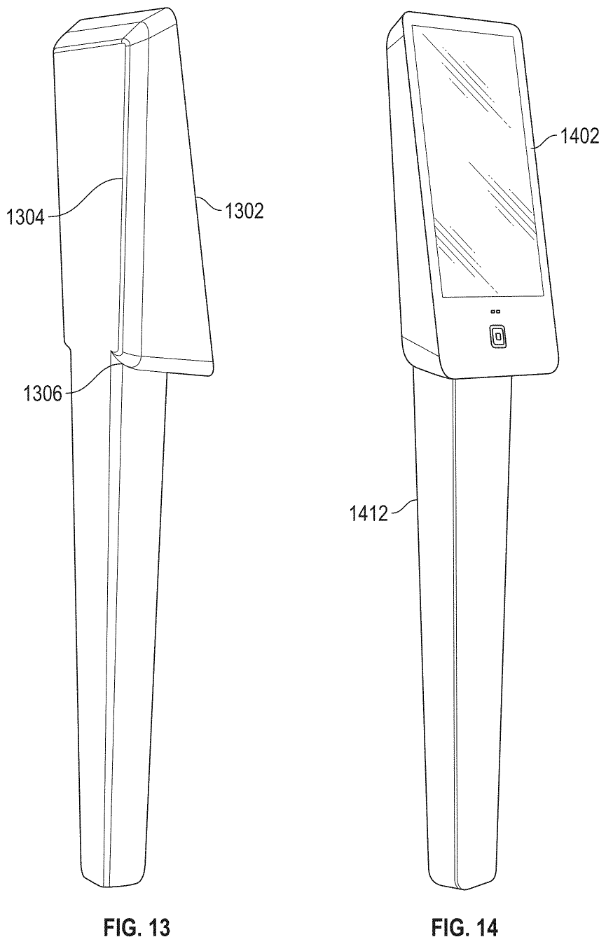

FIG. 13 is a free standing core 1302 and vessel 1304 combination showing the core received within or otherwise supported by the vessel generally along a joint interface 1306 defining a load bearing and load carrying surface interface.

FIG. 14 is an alternate embodiment of a free standing core and vessel combination showing a core 1402 supported by a vessel which includes a stand or column 1412 for supporting the core at a predetermined distance above the ground, for example, such that the screen display associated with the core is at eye level.

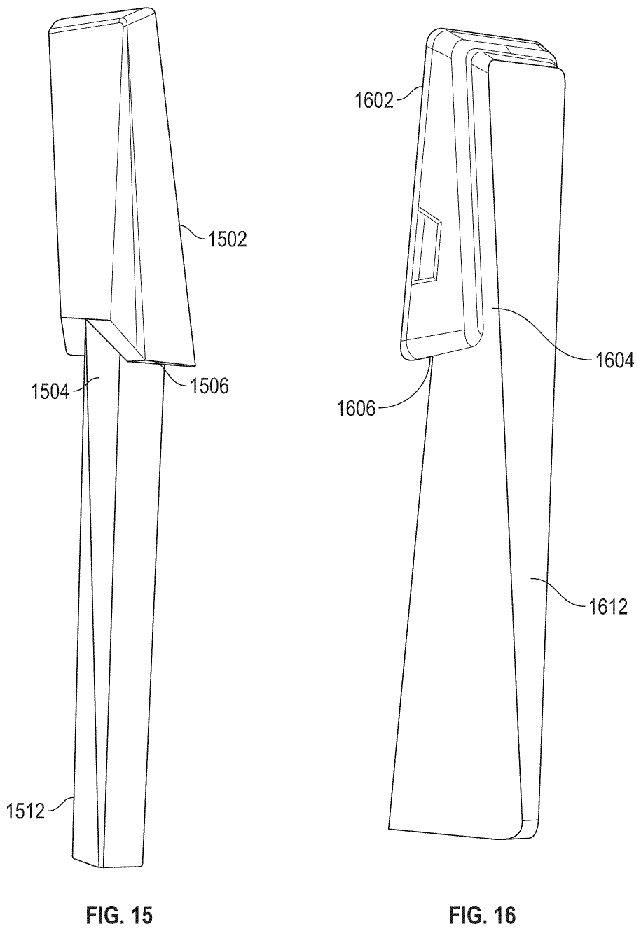

FIG. 15 is a back side perspective view of an alternate embodiment of a free standing core and vessel combinations including a core 1502 supported by a vessel 1504 generally along a joint interface 1506 defining a load bearing and load carrying surface interface. The vessel 1504 includes a stand 1512 for supporting the core at a predetermined distance above the ground.

FIG. 16 is a back side perspective view of a further alternate embodiment of a free standing core and vessel combinations including a core 1602 supported by a vessel 1604 generally along a joint interface 1606 defining a load bearing and load carrying surface interface. The vessel 1604 includes a stand 1612 for supporting the core at a predetermined distance above the base of the vessel.

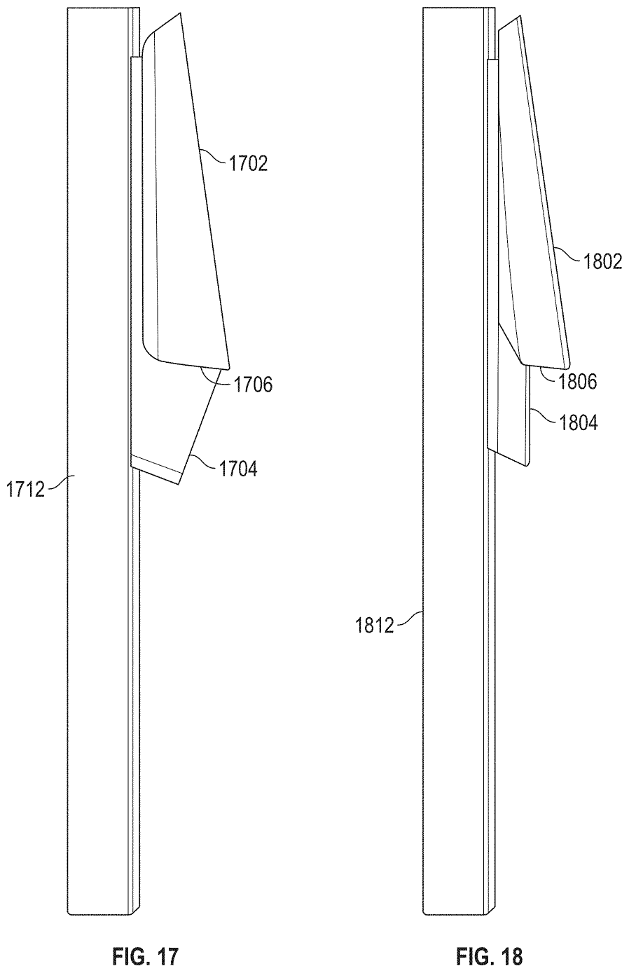

FIG. 17 is a schematic perspective view of a wall mounted core and vessel combination showing a core 1702 received within or otherwise supported by a vessel 1704 which is attached to a wall 1712. The core is supported by the vessel along a joint interface 1706 which generally defines a load bearing/load carrying surface interface.

FIG. 18 is an alternate embodiment of a wall mounted core and vessel combination showing a core 1802 supported by a vessel 1804 attached to a wall 1812. The core is supported by the vessel along a joint interface 1806 which generally defines a load bearing/load carrying surface interface.

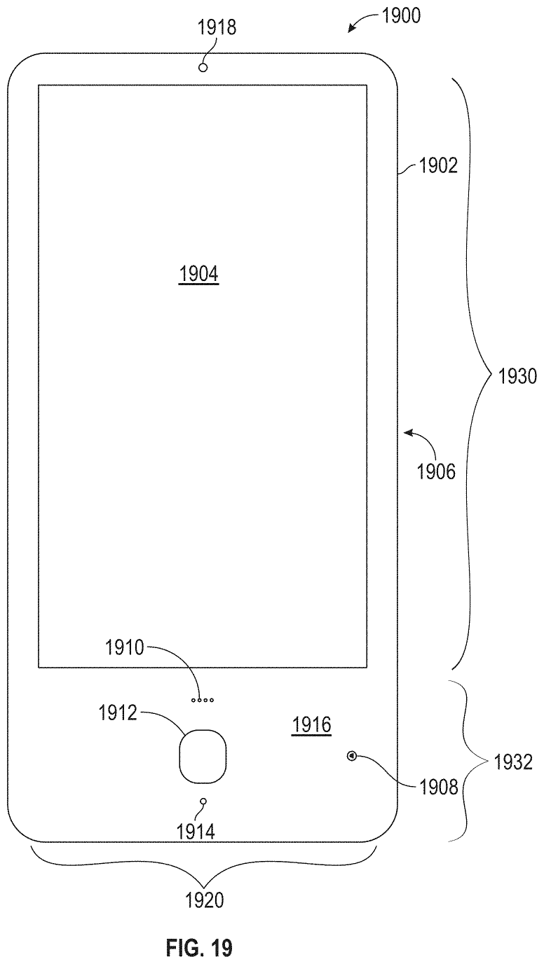

FIG. 19 is a schematic representation of an exemplary kiosk core 1900 including a display screen 1904 (e.g., 15-22 inch) and various peripheral components such as, for example, a side mounted payment module 1906, an NFC+EMV payment module 1908 integrated into the core, core housing, or front surface of the core (e.g., the display screen or an extended touch surface 1916), notification (e.g., alert) and/or navigation lights (e.g., LEDs) 1910, a navigation pad 1912 (e.g., an ADA module) integrated into or otherwise associated with the front surface of the core, and an audio module 1914 including a microphone and/or speaker. The core also includes a base or bottom portion 1920 comprising a load bearing surface configured to be supported by a corresponding load carrying surface of a vessel to which the core may be paired.

With continued reference to FIG. 19, although the peripheral devices are schematically shown as being appurtenant to the core, it will be appreciated that one or more of the devices may be integrated with or attached to a vessel, with electrical communication between the devices and the core provided by an integrated and/or passive electrical interface.

FIG. 19 further illustrates a continuous front panel surface 1902 comprising an active touch screen region 1930 and an extended region 1932 which may or may not also be touch interactive. If the extended region 1932 is not touch interactive, the various components mounted thereon or integrated thereinto may be touch passive; if the extended region 1932 is touch interactive, these components may also be touch interactive.

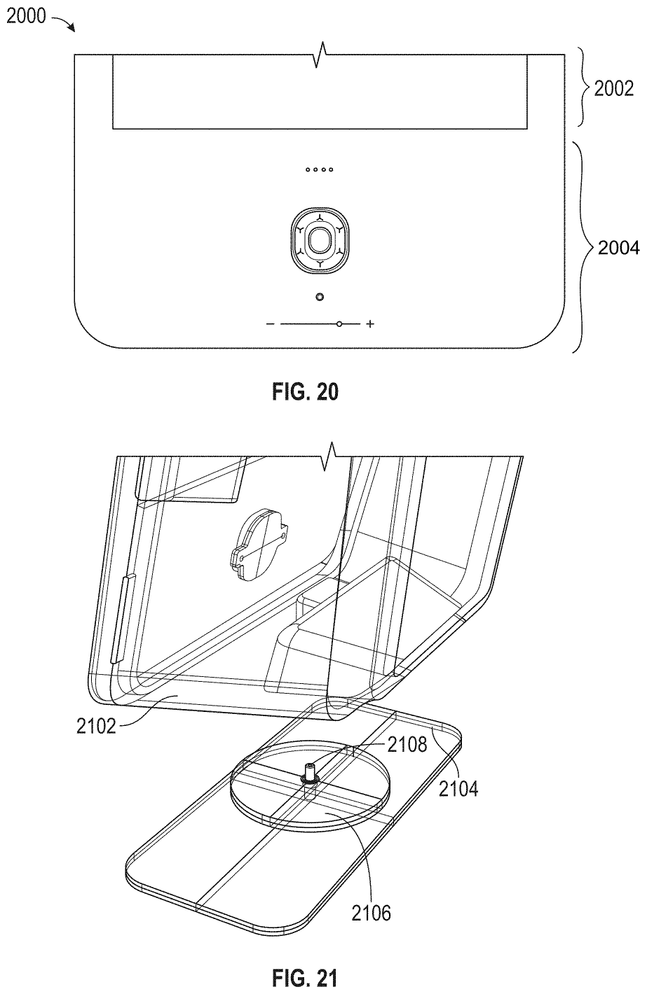

With momentary reference to FIG. 20, a core unit 2000 includes a substantially planar front face having a display region 2002 and an extended region 2004, where either or both regions may be touch interactive. If the extended region 2004 is touch interactive, the illustrated components may be coplanar with the front surface; alternatively, a portion of the components may extend out of the plane of the front surface to facilitate tactile location and/or manipulation of the peripheral component(s).

Referring now to FIGS. 21-23, a universal (or otherwise multidimensional) mounting interface may be used to mount a core or a core/vessel combination to a surface. More particularly, FIG. 21 shows a core (or core/vessel combination) 2102 positioned above a base 2104 having a swivel mechanism 2106 and a base mounting interface (e.g., a dowel) 2108 configured to mate with a corresponding mounting interface in the core (or vessel).

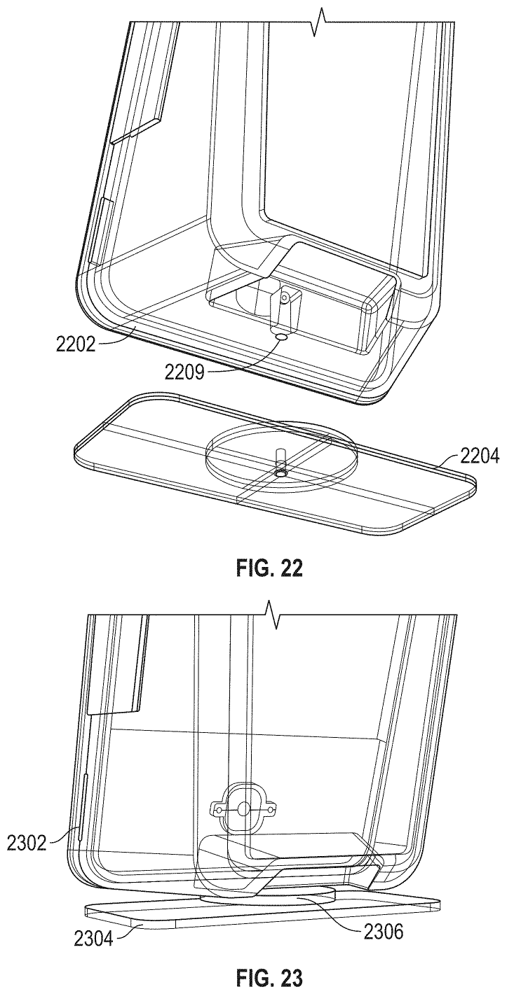

FIG. 22 shows a core (or core/vessel) 2202 having a core mounting interface (e.g., through hole 2209) positioned above a mounting base 2204.

FIG. 23 shows the core (or core/vessel) 2302 mounted with the base 2304 atop a swivel 2306, with the core mounting interface mated with the base mounting interface (not shown in FIG. 23).

Presently known kiosks are typically “monolithic” in the sense that the primary functional components are integrated within a single enclosure or housing. While this approach supports large volume deployments of the same or substantially similar kiosks, it is impractical in view of the variability from customer-to-customer and from use case to use case in terms of specific attributes including the following Mounting and Placement methodologies: Freestanding (floorstanding), wherein the unit rests on a floor under gravity (unaffixed with fasteners); Fixed installation, wherein the unit is affixed to the floor or ceiling of an interior or exterior space through fasteners; Wall mount, wherein the unit is affixed to an interior or exterior wall through bracketry or fasteners; Countertop, wherein the unit rests on a countertop under gravity or is affixed to the countertop through bracketry or fasteners.

Additional variables include Electronic and Mechanical Components used to achieve the specific functionality required, including the following peripheral components: Printers; Biometric devices; Barcode scanners; OCR Scanners; Cameras; RFID readers; Networking devices; Secondary displays; Shelving; Additional compartments; Electronic Latches; Weigh scales; Audio devices; Cash and coin acceptance and cash dispensing systems; and Indicator lights.

Notwithstanding the above, there are certain common elements that tend to occur across the majority of kiosks, which include items such as: Displays, including touchscreen displays; Computing devices; Payment devices; and Accessibility panels required for legal compliance with Americans with Disabilities Act (or other equivalent legislation specific to various jurisdictions).

In contrast to a traditional monolithic approach, one aspect of the present invention contemplates a departure from the monolithic kiosk structure in favor of: i) a “core” unit (or small set of core units) each containing a specific sub-set of the common attributes referenced above; ii) a series of “vessel” support structures or enclosures, each containing a specific sub-set of desired attributes/features, where the vessel are configured to mate with the “core” unit(s) to thereby support the corresponding core attributes (e.g., peripherals) described above; and iii) one or more of a plurality of standardized electrical/mechanical/network connections between core and vessel to thereby enable any core to mate with any vessel.

Either or both of the power connection and data connections may contemplate wireless transmission at the interface (e.g., Bluetooth or near field communication (NFC) for data; inductive power transmission).

The use of a single universal mechanical mounting point at the base of the unit (like a camera tripod with adjustable resistance to swiveling) should be included in the set of potential embodiments to enable a wide range of flexibility and features, including enabling the kiosk to be swiveled to different angles.

This core/vessel approach promotes customer specified peripheral and attribute configurations, while at the same time offering significant cost efficiencies in the design and production of large scale kiosk systems. The core/vessel approach further facilitates “futureproofing” by providing forward and backward compatibility, as explained below.

By way of non-limiting illustrative example, if a customer having an existing core/vessel combination with an existing peripheral configuration desires an alternate or upgraded configuration, they may undock the core and re-dock it into an alternate/upgraded vessel without having to incur the cost of a new core and its associated components. The prior art monolithic paradigm, on the other hand, would likely require the scrapping and/or disassembly of the entire kiosk assembly and/or an entirely new core.

Analogous cost savings may be realized in accordance with the core/vessel paradigm disclosed herein when a customer desires to install an alternate/new/upgraded core unit into an existing vessel due to backwards compatibility of the mechanical, electrical, and/or network connection between the new core and existing vessel.

A further embodiment provides a kiosk configured to run on battery power, using one or more of: i) a core having an integral (e.g., internal) battery; ii) a vessel having an integral battery; and iii) a core/vessel assembly leveraging an external battery. This allows kiosks to be deployed in remote areas on a temporary basis, for example, during sporting events, concerts, disaster recovery, and the like.

A further embodiment includes separate indicator lights beyond (e.g., beneath) an extended glass portion of the display that can guide the operator to engage with a nearby peripheral devices.

Multiple cores can be used with multiple vessels and mixed and matched depending on the operator's requirements quickly adapting to changing requirements. This also allows for redundant cores and/or vessel for back up purposes.

Another embodiment provides for multiple (e.g., two) cores used to form multi-(e.g., double) sided user interfaces sharing a common vessel.

Further core and vessel embodiments can accommodate a rotary feature allowing swiveling of the core relative to the vessel, or swiveling of the core/vessel combination relative to a mounting fixture.

Further embodiments provide an intermediate interface connector between the core and vessel that can accommodate additional external peripherals not included in the vessel.

Further embodiments also include an external interface such as an employee-facing terminal in addition to one or more customer facing displays.

Further embodiments provide user selected or automatic changing between portrait and landscape display configurations. Either with or without a universal mounting point.

Additional embodiments contemplate multiple cores connected together (e.g., daisy chained) using a single vessel.

The Core plus Vessel approach enables the customer to select placement of the peripherals either attached to the core or embedded in a vessel depending on requirements and/or preferences.

Further core/vessel embodiments provide for a dynamically configurable height and angle of the display relative to the floor, counter top, wall mount, or other mounting configuration.

Additionally, a core/vessel assembly may be configured to drive and/or manage one or more external monitors, displays, and/or remote cores.

A modular kiosk system is thus provided which includes: a kiosk including a front surface having a display screen, an oppositely disposed rear surface, and a kiosk interface module disposed proximate the base of the kiosk substantially spanning the front and rear surfaces, the kiosk interface module including a kiosk load bearing component; a counter top cradle configured to support the kiosk on a counter top, the counter top cradle having a first interface module including a first load carrying component configured to releasably mate with the kiosk load bearing component to support the weight of the kiosk when the kiosk is paired with the counter top cradle; and a wall mount cradle configured to support the kiosk on a wall, the wall mount cradle having a second interface module including a second load carrying component configured to releasably mate with the kiosk load bearing component to support the weight of the kiosk when the kiosk is paired with the wall mount cradle.

In an embodiment, the kiosk interface module further comprises a kiosk electrical connector.

In an embodiment, the first interface module further comprises a first electrical connector configured for coupling to the kiosk electrical connector when the kiosk is paired with the counter top cradle.

In an embodiment, the second interface module further comprises a second electrical connector configured for coupling to the kiosk electrical connector when the kiosk is paired with the wall mount cradle.

In an embodiment, the kiosk system further comprises a free standing cradle configured to support the kiosk at a fixed distance above the floor, the free standing cradle having a third interface module including a third load carrying component configured to releasably mate with the kiosk load bearing component to support the weight of the kiosk when the kiosk is paired with the free standing cradle.

In an embodiment, the kiosk interface module further comprises a kiosk electrical connector; the first interface module further comprises a first electrical connector configured for coupling to the kiosk electrical connector when the kiosk is paired with the counter top cradle; the second interface module further comprises a second electrical connector configured for coupling to the kiosk electrical connector when the kiosk is paired with the wall mount cradle; and the third interface module further comprises a third electrical connector configured for coupling to the kiosk electrical connector when the kiosk is paired with the free standing cradle.

In an embodiment, the kiosk electrical connector is configured to exchange data signals with the corresponding cradle electrical connector to which it is coupled.

In an embodiment, the kiosk electrical connector comprises one of: i) a universal serial bus (USB) connector; ii) a pin connector; and iii) a wireless data transfer module.

In an embodiment, the kiosk electrical connector is further configured to supply power to the corresponding cradle electrical connector to which it is coupled.

In an embodiment, the kiosk load bearing component comprises a self-guiding structural feature.

A kiosk core is also provided, the core being configured to be paired with at least two of the following vessels: i) a counter top vessel having a first interface module including a first load carrying component; ii) a wall mount vessel having a second interface module including a second load carrying component; and iii) a free standing vessel having a third interface module including a third load carrying component. The kiosk core includes a front surface having a display screen, an oppositely disposed rear surface, and a kiosk interface module including a kiosk load bearing component. The kiosk interface module satisfies at least two of the following criteria: i) the first load carrying component cooperates with the kiosk load bearing component to support the weight of the kiosk when the kiosk is paired with the counter top cradle; ii) the second load carrying component cooperates with the kiosk load bearing component to support the weight of the kiosk when the kiosk is paired with the wall mount cradle; and iii) the third load carrying component cooperates with the kiosk load bearing component to support the weight of the kiosk when the kiosk is paired with the free standing cradle.

In an embodiment, the kiosk core further includes a downwardly facing bottom surface extending between the front and rear surfaces proximate a base region of the kiosk core; wherein the kiosk interface module is disposed proximate the bottom surface.

In an embodiment, the first, second, and third interface modules comprise first, second, and third electrical connectors, respectively; the kiosk interface module further includes a kiosk electrical connector configured to couple to at least two of the following: i) the first electrical connector when the kiosk is paired with the counter top vessel; ii) the second electrical connector when the kiosk is paired with the wall mount vessel; and iii) the third electrical connector when the kiosk is paired with the free standing vessel.

In an embodiment, the kiosk core further includes a downwardly facing bottom surface extending between the front and rear surfaces proximate a base region of the kiosk core; and the kiosk interface module is disposed proximate the bottom surface.

A modular kiosk system is also provided, the system including: a first vessel including a first peripheral device, a first load carrying portion, and a first electrical connector; a second vessel including a second peripheral device, a second load carrying portion, and a second electrical connector; and a core having a display screen, a processor configured to control user interaction with the first peripheral device and the second peripheral device, and a core mounting interface. The core mounting interface includes: i) a load bearing component configured to be: a) coupled to the first load carrying component when the core is paired with the first vessel; and b) coupled to the second load carrying component when the core is paired with the second vessel. The core mounting interface also includes ii) a core electrical connector configured to be: a) coupled to the first electrical connector when the core is paired with the first vessel; and b) coupled to the second electrical connector when the core is paired with the second vessel.

In an embodiment, the kiosk system further includes a downwardly facing bottom surface extending between front and rear surfaces of the core proximate a base region of the core; wherein the core mounting interface module is disposed proximate the bottom surface.

In an embodiment, the first peripheral device comprises a first one of, and the second peripheral device comprises a second one of: a printer, bar code scanner, payment module, biometric scanner, and a near field communication device.

In an embodiment, the first and second vessels each comprise one of counter top, wall mount, and free standing support structure.

In an embodiment, the kiosk system further includes a third vessel having a third peripheral device, and a plurality of identical cores each of which may be interchangeably paired with either the first, second, and third vessel.

A kiosk core is also provided, the core being configured to be selectively paired with a first vessel modality having a first load supporting structure and a second vessel modality having a second load supporting structure. The core includes at least one self-guiding load bearing structure configured to be supported by the first and second load supporting structures.

A kiosk system is provided which includes: a core having a display, a load bearing surface, and a core electrical interface; a first vessel having a first peripheral device, a first load carrying interface configured to support the load bearing surface, and a first electrical interface configured to mate with the core electrical interface to thereby provide power to the core and exchange data between the core and the first peripheral device; and a second vessel having a second peripheral device, a second load carrying interface configured to support the load bearing surface, and a second electrical interface configured to mate with the core electrical interface to thereby provide power to the core and exchange data between the core and the second peripheral device.

In an embodiment, the core further comprises a downwardly facing bottom surface extending between front and rear surfaces of the display proximate a base region of the core; and the load bearing surface is proximate the bottom surface.

In an embodiment, the first peripheral device comprises a first one of a printer, bar code scanner, payment module, biometric scanner, and a near field communication device; and the second peripheral device comprises a second one of a printer, bar code scanner, payment module, biometric scanner, and a near field communication device.

In an embodiment, the first and second vessels each comprise one of a counter top, wall mount, and free standing support structure.

In an embodiment, the system further includes: a third vessel having a third peripheral device; and a plurality of substantially identical cores each of which may be interchangeably paired with the first, second, and third vessels

As used herein, the word “exemplary” means “serving as an example, instance, or illustration.” Any implementation described herein as “exemplary” is not necessarily to be construed as preferred or advantageous over other implementations, nor is it intended to be construed as a model that must be literally duplicated.

While the foregoing detailed description will provide those skilled in the art with a convenient road map for implementing various embodiments of the invention, it should be appreciated that the particular embodiments described above are only examples, and are not intended to limit the scope, applicability, or configuration of the invention in any way. To the contrary, various changes may be made in the function and arrangement of elements described without departing from the scope of the invention.

1. A modular kiosk system comprising:
a kiosk having a front surface having a display screen, an oppositely disposed rear surface, a downwardly facing bottom surface extending between the front and rear surfaces proximate a base region of the kiosk, a kiosk interface module disposed on the bottom surface and including a kiosk load bearing component comprising one or more load bearing surfaces, and at least one of a Near Field Communication (NFC) and an Europay, Mastercard and Visa (EMV) payment module;
a counter top cradle configured to support the kiosk on a counter top, the counter top cradle having a first interface module including a first load carrying component comprising a first load carrying surface configured to releasably mate with the one or more load bearing surfaces of the kiosk load bearing component positioned above to hold the kiosk in a substantially vertical orientation such that to support the weight of the kiosk when the kiosk is paired with the counter top cradle; and
a wall mount cradle configured to support the kiosk on a wall, the wall mount cradle having a second interface module including a second load carrying component comprising a second load carrying surface configured to releasably mate with the one or more load bearing surfaces of the kiosk load bearing component positioned above hold the kiosk in a substantially vertical orientation such that to support the weight of the kiosk when the kiosk is paired with the wall mount cradle, wherein the counter top cradle and the wall mount cradle are separate devices;
wherein the kiosk is inter-changeably paired with the counter top cradle and the wall mount cradle.

2. The kiosk system of claim 1, wherein the kiosk interface module further comprises a kiosk electrical connector.

3. The kiosk system of claim 2, wherein the first interface module further comprises a first electrical connector configured for coupling to the kiosk electrical connector when the kiosk is paired with the counter top cradle.

4. The kiosk system of claim 3, wherein the second interface module further comprises a second electrical connector configured for coupling to the kiosk electrical connector when the kiosk is paired with the wall mount cradle.

5. The kiosk system of claim 1, further comprising:
a free standing cradle configured to support the kiosk at a fixed distance above the floor, the free standing cradle having a height that corresponds to the fixed distance above the floor, and a third interface module including a third load carrying component configured to releasably mate with the kiosk load bearing component to support the weight of the kiosk when the kiosk is paired with the free standing cradle.

6. The kiosk system of claim 5, wherein:
the kiosk interface module further comprises a kiosk electrical connector;
the first interface module further comprises a first electrical connector configured for coupling to the kiosk electrical connector when the kiosk is paired with the counter top cradle;
the second interface module further comprises a second electrical connector configured for coupling to the kiosk electrical connector when the kiosk is paired with the wall mount cradle; and
the third interface module further comprises a third electrical connector configured for coupling to the kiosk electrical connector when the kiosk is paired with the free standing cradle.

7. The kiosk system of claim 4, wherein the kiosk electrical connector is configured to exchange data signals with the corresponding cradle electrical connector to which it is coupled.

8. The kiosk system of claim 7, wherein the kiosk electrical connector comprises one of: i) a universal serial bus (USB) connector; ii) a pin connector; and iii) a wireless data transfer module.

9. The kiosk system of claim 4, wherein the kiosk electrical connector is further configured to supply power to the corresponding cradle electrical connector to which it is coupled.

10. (canceled)

11. A kiosk core configured to be paired with at least two of the following vessels: i) a counter top vessel having a first interface module including a first load carrying component comprising a first load carrying surface; ii) a wall mount vessel having a second interface module including a second load carrying component comprising a second load carrying surface; and iii) a free standing vessel having a third interface module including a third load carrying component comprising a third load carrying surface, the kiosk core, wherein the counter top vessel, the wall mount vessel, and the free standing vessel are separate devices; comprising:
a front surface having a display screen, an oppositely disposed rear surface, a downwardly facing bottom surface extending between the front and rear surfaces proximate a base region of the kiosk, a kiosk interface module disposed on the bottom surface and including a kiosk load bearing component comprising one or more load bearing surfaces configured to at least two of: the first load carrying surface of the counter top vessel, the second load carrying surface of the wall mount vessel, and the third load carrying surface of the free standing vessel, and at least one of a Near Field Communication (NFC) and an Europay, Mastercard and Visa (EMV) payment module;
wherein the kiosk interface module satisfies at least two of the following criteria:
i) the first load carrying component cooperates with the kiosk load bearing component positioned above to hold the kiosk core in a substantially vertical orientation such that to support the weight of the kiosk when the kiosk is paired with the counter top cradle;
ii) the second load carrying component cooperates with the kiosk load bearing component positioned above to hold the kiosk core in a substantially vertical orientation such that to support the weight of the kiosk when the kiosk is paired with the wall mount cradle; and
iii) the third load carrying component cooperates with the kiosk load bearing component positioned above to hold the kiosk core in a substantially vertical orientation such that to support the weight of the kiosk when the kiosk is paired with the free standing cradle.

12. (canceled)

13. The kiosk core of claim 11, where the first, second, and third interface modules comprise first, second, and third electrical connectors, respectively;
the kiosk interface module further comprising a kiosk electrical connector configured to couple to at least two of the following:
i) the first electrical connector when the kiosk is paired with the counter top vessel;
ii) the second electrical connector when the kiosk is paired with the wall mount vessel; and
iii) the third electrical connector when the kiosk is paired with the free standing vessel.

14. (canceled)

15. A modular kiosk system comprising:
a first vessel including a first peripheral device, a first load carrying portion, and a first electrical connector;
a second vessel including a second peripheral device, a second load carrying portion, and a second electrical connector, wherein the first vessel and the second vessel are separate devices; and
a kiosk core having a display screen, at least one of a Near Field Communication (NFC) and an Europay, Mastercard and Visa (EMV) payment module, and a processor configured to control user interaction with the first peripheral device and the second peripheral device and a core mounting interface comprising:
i) a load bearing component configured to be: a) coupled to the first load carrying component when the kiosk core is paired with the first vessel; and b) coupled to the second load carrying component when the kiosk core is paired with the second vessel; and
ii) a core electrical connector configured to be: a) coupled to the first electrical connector when the kiosk core is paired with the first vessel; and b) coupled to the second electrical connector when the kiosk core is paired with the second vessel.

16. A kiosk system comprising:
a core having a display, a load bearing surface, a core electrical interface, and at least one of a Near Field Communication (NFC) and an Europay, Mastercard and Visa (EMV) payment module;
a first vessel having a first peripheral device, a first load carrying interface configured to support the load bearing surface, and a first electrical interface configured to mate with the core electrical interface to thereby provide power to the core and exchange data between the core and the first peripheral device; and
a second vessel having a second peripheral device, a second load carrying interface configured to support the load bearing surface, and a second electrical interface configured to mate with the core electrical interface to thereby provide power to the core and exchange data between the core and the second peripheral device, wherein the first vessel and the second vessel are separate devices.

17. The kiosk system of claim 16, wherein:
the core further comprises a downwardly facing bottom surface extending between front and rear surfaces of the display proximate a base region of the core; and
the load bearing surface is proximate to the bottom surface.

18. The kiosk system of claim 16, wherein:
the first peripheral device comprises a first one of a printer, bar code scanner, payment module not including NFC or EMV modules, biometric scanner, and a near field communication device; and
the second peripheral device comprises a second one of a printer, bar code scanner, payment module not including NFC or EMV modules, biometric scanner, and a near field communication device.

19. The kiosk system of claim 16, wherein the first and second vessels each comprise one of a counter top, wall mount, and free standing support structure.

20. The kiosk system of claim 16, further comprising:
a third vessel having a third peripheral device; and
a plurality of substantially identical cores each of which may be interchangeably paired with the first, second, and third vessels.

21. The kiosk system of claim 1, wherein the first load carrying interface and the second load carrying interface are a same load carrying surface.

22. The kiosk system of claim 1, wherein the first load carrying interface and the second load carrying interface are difference load carrying surfaces.

23. The kiosk core of claim 11, wherein the first load carrying interface, the second load carrying interface, and the third load carrying interface are a same load carrying surface.
